(19) United States
(12) Patent Application Publication
(10) Pub. No.: US 2018/0274807 A1
(43) Pub. Date: Sep. 27, 2018

(54) HVAC SYSTEM WITH AUDIO CAPABILITIES

(71) Applicant: Trane International Inc., Davidson, NC (US)

(72) Inventors: Ronald Maurice Cosby, II, La Crosse, WI (US); Gregory Lee Meeuwsen, West Salem, WI (US)

(73) Assignee: Trane International Inc., Davidson, NC (US)

(21) Appl. No.: 15/694,466

(22) Filed: Sep. 1, 2017

Related U.S. Application Data
(63) Continuation-in-part of application No. 15/466,031, filed on Mar. 22, 2017, now abandoned.

(51) Int. Cl. F24F 11/00; G06F 3/16; G05B 19/042

(52) U.S. Cl. CPC F24F 11/006; F24F 11/0076; F24F 11/008; G06F 3/167; G05B 2219/2614; G05B 19/042; F24F 2011/0061; F24F 2011/0083; F24F 2011/0091; F24F 11/0086

(57) ABSTRACT

A control system configured for use with a heating, ventilation and air condition system (HVAC), the system is provided. The control system includes a terminal device disposed proximate to a space in which the control system is configured to regulate a flow of air, an audio output device operatively coupled to the terminal device and configured to output audio into the space, and a controller that is communicatively coupled to each of the terminal device and the audio output device for control thereof.

### CROSS-REFERENCE TO RELATED APPLICATION

This application is a Continuation-In-Part of U.S. application Ser. No. 15/466,031 entitled “HVAC SYSTEM WITH AUDIO CAPABILITIES” and filed Mar. 22, 2017, the entirety of which is hereby incorporated by reference herein for all purposes.

### BACKGROUND

### Field of the Disclosure

The present disclosure relates, generally, to a heating, ventilation and air condition system (HVAC), and more particularly, to an HVAC system with audio capabilities.

### Description of the Related Art

HVAC systems which regulate environmental conditions within an enclosed area of a commercial building (or residential home) are known. With respect to commercial buildings, the HVAC systems are typically controlled by a building automation system (BAS) or HVAC equipment control system. The BAS can also be used to control security, lighting, power, etc. of the commercial building; residential systems are, typically, controlled by a thermostat, e.g., a smart thermostat.

Commercial buildings sometimes include one or more types of audio systems (e.g., intercom systems, music systems, alarm systems, etc.). Such systems, however, are wired separately from the HVAC systems and are controlled by a system (or device) other than the BAS or HVAC equipment control system.

As can be appreciated, building owners bear the burden of increased costs when having to install an HVAC system including a BAS (or equipment controller system) and an audio system including its own separate control system.

### SUMMARY

The present disclosure has been made to address the above problems and disadvantages, and to provide at least the advantages described below.

In accordance with an aspect of the present disclosure, there is provided a control system. The control system includes a terminal device disposed proximate to a space in which the control system is configured to regulate a flow of air, an audio output device operatively coupled to the terminal device and configured to output audio into the space, and a controller that is communicatively coupled to each of the terminal device and the audio output device, which can be a speaker, for control thereof.

The terminal device can be one of a variable air-volume (VAV) box, a fan coil, a blower coil, a ventilator, and a variable refrigerant flow (VRF) cassette, a personal terminal air conditioner (PTAC), a water source heat pump (WSHP), a cooling coil, and a chilled beam cassette. The audio output device can be incorporated into a register that is operatively coupled to the terminal device.

The controller communicates with the terminal device and the audio output device via a wired interface and/or wireless interface, and the wireless interface can be one of AirFi™ and wireless-fidelity (WiFi).

The control system can also include a microphone that is operatively coupled to the terminal device and configured to detect an audio input. When an audio input detected by the microphone is less than or equal to a predetermined value, the controller controls a white noise generator to output white noise through the audio output device.

The audio output by the audio output device can be provided by a music service provider and music that is stored on one of a local network server, a cloud based server, a connected smart device and an intercom based single input. Moreover, the controller can be communicatively couplable to a smart device including one of a smart watch, a smart phone, a smart tablet, smart remote, and a smart thermostat for allowing a user of one of the smart devices to control a type of audio output by the audio output device.

In accordance with an aspect of the present disclosure, there is provided a BAS. The BAS includes a plurality of terminal devices, each capable of regulating a flow of air into an adjacent space, a plurality of speakers, each operatively coupled to a corresponding one of the plurality of terminal devices and configured to output audio, and a controller that is communicatively coupled to the plurality of terminal devices and the plurality of speakers for control thereof. Each of the plurality of speakers can be incorporated into a register of a corresponding one of the plurality of terminal devices.

The controller communicates with the plurality of the terminal devices and the plurality of speakers via a wired interface and/or wireless interface, and the wireless interface can be one of AirFi™ and WiFi.

The BAS can include a plurality of microphones, and each microphone can be operatively coupled to a corresponding one of the plurality of terminal devices and configured to detect an audio input. When an audio input detected by the microphones is less than or equal to a predetermined value, the controller controls a white noise generator to output white noise through a corresponding one of the plurality of speakers.

The audio output by the plurality of speakers can be provided by a music service provider and music that is stored on one of a local network server, a cloud based server, a connected smart device and an intercom based single input. Moreover, the controller can be communicatively couplable to a smart device including one of a smart watch, a smart phone, a smart tablet, smart remote, and a smart thermostat for allowing a user of one of the smart devices to control a type of audio output by the plurality of speaker,

In accordance with an aspect of the present disclosure, there is provided an upgrade kit for a control system including at least one terminal device and at least one speaker operatively coupled to the at least one terminal device. The upgrade kit includes a non-transitory computer readable storage medium having stored thereon executable instructions that when executed by a controller of the control system perform a method comprising downloading, via the controller, audio from a music server, controlling the at least one terminal device for regulating a flow of air in a space where the at least one terminal device is located, and controlling the at least one speaker for outputting the downloaded audio into the space where the at least one terminal device box is located. The BAS can include at least two terminal device and at least two speaker operatively coupled to a corresponding one of the at least two terminal devices, wherein the at least two speakers can output different audio.

### BRIEF DESCRIPTION OF THE DRAWINGS

The embodiments of the present invention may be more completely understood in consideration of the following detailed description of various embodiments in connection with the accompanying drawings, in which:

FIG. 1 is a diagram of a building including a BAS configured to control an HVAC system including multiple terminal devices, according to an embodiment of the present disclosure;

FIG. 2A is a diagram of the BAS and HVAC system including the multiple terminal devices;

FIG. 2B is a detailed diagram of the indicated area of FIG. 2A;

FIG. 3 is a diagram of an embodiment of a thermostat that is configured for use with a BAS and/or an HVAC system in accordance with the present disclosure;

FIGS. 4A-4C are diagrams of control systems configured for use with HVAC systems;

FIGS. 5A and 5B are diagrams of a water source heat pump with audio capabilities in accordance with an embodiment of the present disclosure; and

FIG. 5C is a diagram of an HVAC system having water source heat pumps with audio capabilities in accordance with an embodiment of the present disclosure.

The various aspects of the present disclosure mentioned above are described in further detail with reference to the aforementioned figures and the following detailed description of embodiments.

### DETAILED DESCRIPTION

The systems and methods of the invention can be utilized in a local or widely distributed building automation system (BAS), from a space or building level to an enterprise level, encompassing virtually any structure, cluster, campus, and area in between. The systems and methods are particularly suited for a dynamically extensible and automatically configurable BAS and architecture, such as those disclosed in U.S. patent application Ser. No. 11/208,773, now U.S. Pat. No. 8,050,801, filed Aug. 22, 2005, entitled “Dynamically Extensible and Automatically Configurable Building Automation System and Architecture”; U.S. patent application Ser. No. 11/316,687, now U.S. Pat. No. 8,099,178, filed Dec. 22, 2005, entitled “Building Automation System Facilitating User Customization”; U.S. patent application Ser. No. 11/316,699, now U.S. Pat. No. 7,904,186, filed Dec. 22, 2005, entitled “Building Automation System Facilitating User Customization”; U.S. patent application Ser. No. 11/316,702, now U.S. Pat. No. 8,024,054, filed Dec. 22, 2005, entitled “Building Automation System Facilitating User Customization”; U.S. patent application Ser. No. 11/316,695, now U.S. Pat. No. 7,870,090, filed Dec. 22, 2005, entitled “Building Automation System Data Management”; U.S. patent application Ser. No. 11/316,697, now U.S. Pat. No. 8,055,386, filed Dec. 22, 2005, entitled “Building Automation System Data Management”; U.S. patent application Ser. No. 11/316,698, now U.S. Pat. No. 8,055,387, filed Dec. 22, 2005, entitled “Building Automation System Data Management”; U.S. patent application Ser. No. 11/316,703, now U.S. Pat. No. 7,917,232, filed Dec. 22, 2005, entitled “Building Automation System Data Management”; and U.S. patent application Ser. No. 11/316,410, now U.S. Pat. No. 8,290,627, filed Dec. 22, 2005, entitled “Dynamically Extensible and Automatically Configurable Building Automation System and Architecture,” all of which are assigned to the assignee of the present application, and are herein incorporated by reference.

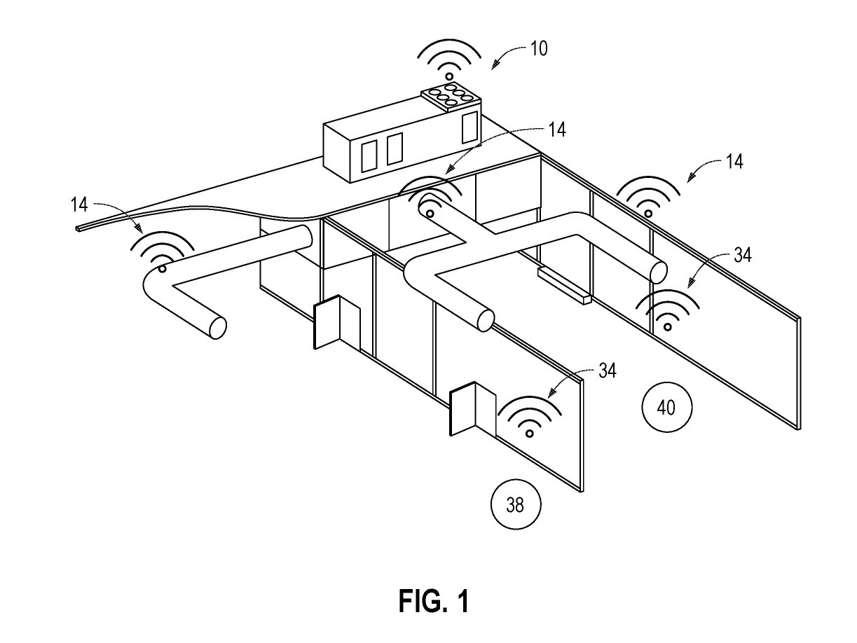

In view of the increased costs that can burden a building owner when having to install an HVAC system and a separate audio system, an HVAC system with audio capabilities would prove useful in the HVAC industry, and such an HVAC system is now herein described. More particularly, FIG. 1 is a diagram of a building (e.g., a large building or campus) including a BAS 10 configured to control an HVAC system 12 including multiple terminal devices 14, according to an embodiment of the present disclosure.

While the BAS 10 is described herein as the device that is used for controlling the HVAC system 12, the present disclosure is not so limited. For example, when the HVAC system 12 is used for light commercial rooftop systems (or other systems), the BAS 10 may be replaced by an HVAC equipment system controller or a variable refrigerant flow (VRF) controller, as will be described in greater detail below.

Moreover, the multiple terminal devices 10 can be embodied in various forms, including, but not limited to a variable air-volume (VAV) box, a fan coil, a blower coil, a ventilator, a VRF cassette, a personal terminal air conditioner (PTAC), a cooling coil, a chilled beam cassette, etc.

In some embodiments, one or more terminal devices 10 may include at least a part of a water source heat pump (WSHP) system. For example, embodiments of the present disclosure may be included in a console WSHP or a vertical stack WSHP system, such as a Trane Axiom™ Console WSHP system or a Trane Axiom™ Vertical Stack WSHP system.

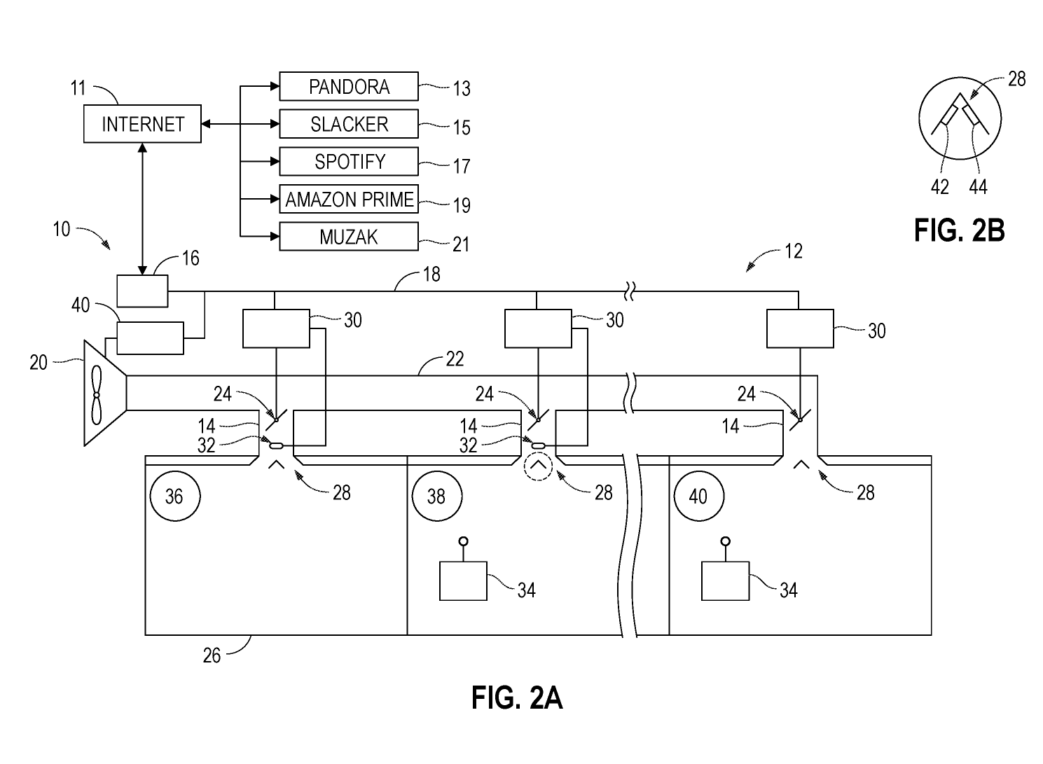

FIG. 2A is a diagram of the BAS 10 and HVAC system 12 including multiple terminal devices 14. In the present illustrative embodiment, the multiple terminal devices are multiple VAV boxes 14. The BAS 10 includes a building automation controller (BAC) 16 (shown schematically in FIG. 2A) that includes the requisite hardware and software for controlling and managing the overall operations of the HVAC 12 for regulating a flow of air and an audio output into one or more adjacent spaces in the building.

The BAC 16 can communicate, via a wired or wireless interface 18, with the components of the HVAC system 12. For example, the BAC 16 can communicate with the components of the HVAC 12 using a wireless communication protocol including, without limitation, any variant of IEEE 802.11 (commonly known as WiFi), variants of IEEE 802.15 wireless personal area networking such as Bluetooth® and Z-Wave®, and other wireless standards such as ZigBee® or the AirFi™ protocol promulgated by Trane International Inc. of Davidson, N.C., USA. Alternatively, the BAC 16 can be configured to communicate using a wired protocol using dedicated data lines (e.g., Ethernet) or via powerline communication links using, for example, IEEE 1901, X10® and/or Insteon® protocol.

Additionally or alternatively, the BAC 16 can be configured to communicate using a wide area cellular mobile network using, for example and without limitation, a GSM protocol (3G, 4G, LTE etc.), a CDMA protocol (EV-DO, SV-DO, etc.), and so forth.

The BAC 16 can include a data interface module (not shown), which can function as a WiFi/AirFi™ hot-spot or wired router to enable the BAC 16 and/or the components of the HVAC system 12 (e.g., a smart thermostat) or other components (e.g., one or more smart devices including, without limitation, a smart watch, a smart phone, a smart tablet, smart remote, etc.) in operative communication with the BAC 16 to connect to the Internet 11.

In addition to the conventional functions that the BAC 16 is configured to perform, the BAC 16 can also communicate via the wired or wireless interface 18 (network 18) to one or more music service providers (e.g., Pandora™ 13, Slacker™ 15, Spotify™ 17, Amazon Prime™ 19, Muzak™ 21 etc.), thereby allowing an owner of the building or an occupant of the building to download/stream music from one of these music service providers via the BAS 10, as will be described in greater detail below. With the combination of these two functions, a building owner or an installer can provide not only variable air volume, but also a speaker system, which can also be used as an intercom, as will be described in greater detail below.

Continuing with reference to FIG. 2A, the BAS 10 is configured to control a single air source 20 which supplies conditioned air to the VAV box 14 (multiple VAV boxes 14 are shown in the Figs.) through a duct (or conduit) 22. One or more dampers 24 under the control of the BAC 16 regulate the flow of air from the duct 22 into an associated space 26 through a diffuser (or register) 28. The dampers 24 can be actuated by a control unit 30 associated with each VAV box 14 in response to changes detected by one or more sensors 32 (e.g., air flow rate sensors, duct pressure sensors, noise sensors, etc.) located either in or near the VAV box 14, or environmental monitors such as a smart thermometer 34, thermostats, humidity sensors or other devices located in the space 26 being supplied with conditioned air through the VAV box 14.

The control unit 30 for a VAV box 14 can include a circuit configured to drive a solenoid capable of either fully opening or closing the damper 24 located in the VAV box 14 depending on the presence or absence of an electrical signal. Alternatively, the control unit 30 can include a more advanced programmable logic controller (PLC) capable of communicating through the network 18 with the BAC 16. The control unit 30 can adjust the position of the damper 24 with a stepper motor, or other appropriate actuator, to any of a plurality of positions between fully closed and fully open in response to commands from the BAC 16. Alternatively, the control unit 30 can adjust the damper 24 based on a comparison of measurements provided by the sensors 32, coupled to the control unit 30, and reference values provided to the control unit 30 by the BAC 16.

The control unit 30 also includes a transmitter module (and an optional receiver module, neither shown in the Figures), or a transceiver module, which can be connected to a respective speaker (and microphone) for transmitting (and receiving) audio, as described in more detail below.

The various sensors 32 and the smart thermostat 34, as well as the control unit 30, can be connected to the BAC 16 in a variety of ways, including the network 18 employing one or more of the aforementioned networking protocols.

FIG. 2A depicts a structure employing a combination of both wired and wireless components. More particularly, a first space 36 includes a wired sensor 32 located proximate to the VAV box 14. A second space 38 includes both a wired sensor 32 proximate to the VAV box 14 and a wireless smart thermostat 34 installed in the second space 38. A third space 40 includes a wireless smart thermostat 34 but is not equipped with a VAV box sensor 32. The wired sensor 32 that is located internally to VAV box 14 can be configured as being responsible for monitoring space 36. The second space 38 and third space 40 present illustrations where the wireless smart thermostat 34 can also monitor an individual space either alone or in conjunction with a wired sensor 32.

The BAC 16 is configured to provide audio to the one or more of the spaces 36, 38, 40. With this purpose in mind, one or more speakers 42 are operably coupled to the transmitter module of the control unit 30, are operably coupled to the VAV boxes 14, and are configured to output audio under the control of the BAC 16. For illustrative purposes, in FIG. 2B a speaker 42 is shown coupled to the register 28; optional microphones 44 can be operably coupled to the receiver module of the control unit 30 and to the register 28 for receiving an audio input. The speakers 42 (or microphones 44) communicate with the BAC 16 and/or the control unit 30 via one of the aforementioned wired or wireless communication methods.

Operation of the HVAC system 12 is now herein described. The building owner obtains a subscription to one of the aforementioned music service providers, e.g., Pandora™ thereby allowing the building owner to stream music, via the BAC 16, from a server of a particular music service provider. In the present embodiment, the BAC 16 communicates with the VAV boxes 14 via theAirFi™ wireless protocol, which also allows communication between the individual VAV boxes 14.

Streamed music received from the music service provider is transmitted from the BAC 16 to a transmitter module of a corresponding control unit 30 associated with a particular one of the VAV boxes 14. For example, with respect to space 36, the transmitter module of the control unit 30 associated with space 36 transmits the streamed music received from the BAC 16 to the speaker 42 that is provided on the register 28. As can be appreciated, similar operations can be performed in the spaces 38 and 40.

The type of music streamed into the spaces 36, 38, 40 can be controlled by a building owner using the BAC 16. For example, common areas, e.g., lobby, cafeteria, restroom, corridor, elevator, etc., can be controlled to output a specific music type or genre, e.g., classical, jazz, etc., which can be set as a default music type for those areas. Other areas, which are not common areas, such as individual office spaces, can be controlled to play other types of music, e.g., hit radio, heavy metal, blues, etc., in accordance with an occupant's music preference.

Moreover, with respect to individual spaces, other than streamed music, an occupant of the individual space can play their own stored personal music, which can be stored on one or more suitable storage devices, e.g., a local network server, a cloud based server, a connected smart device, and/or an intercom-based single input such as an endless loop magnetic tape device, CD changer, etc.

The various parameters, e.g., volume, treble bass, fading, etc., of the output music can be controlled by an owner of the building (for the common areas) and/or the occupants (for the individual office spaces). For example, with respect to the common areas, the building owner can use the BAC 16 to control the various parameters of the output music.

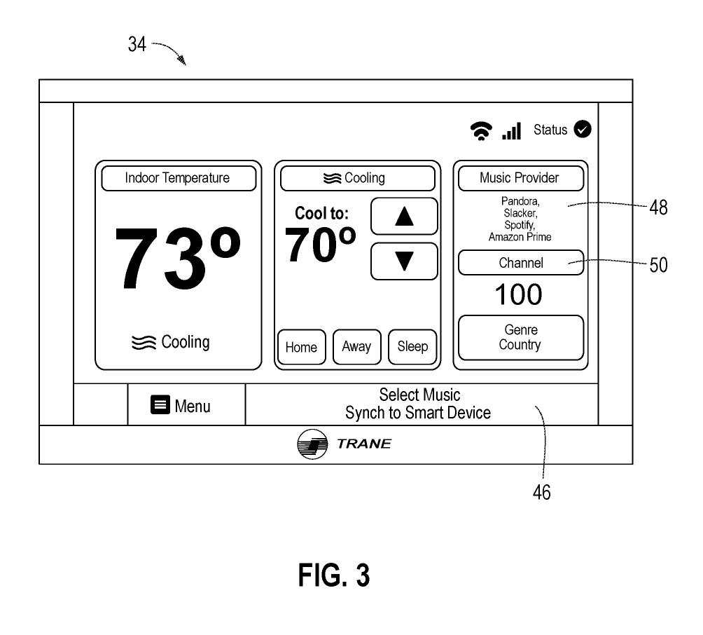

Similarly, with respect to the individual office spaces, the occupants of those spaces can use the control unit 30 and one or more of the smart devices described above to control the various parameters of the output music or the type of music being played. For example, the smart thermostat 34 (see FIG. 3, for example) can be used to communicate with the control unit 30. To this end, the smart thermostat 34 can be configured to display a graphical user interface (GUI) 46 on a touch screen of the smart thermostat 34 that is configured to receive a user's touch input for placing the smart thermostat 34 in a music mode. A detected touch input on the GUI 46 displays a GUI 48 that allows a user to select a specific music service provider and a GUI 50 that allows a user to select a channel of the selected music service provider.

As can be appreciated, various virtual buttons, arrows, or other touch screen user icons can be displayed on the touch screen of the smart thermostat 34 to enable a user to make the various selections associated with the music mode of the smart thermostat 34. Additionally or alternatively, one or more mechanical buttons on the smart thermostat 34 can be used for making one or more the music selections.

Music information associated with a user's selection is transmitted from the smart thermostat 34 to the control unit 30. With respect to volume, for example, the control unit 30 can be configured to adjust this parameter directly without having to communicate with the BAC 16. With respect to the type of music being streamed or to be streamed, the control unit 30 can transmit a command/request signal to the BAC 16 for changing/choosing a type of music.

Alternatively or additionally, the smart thermostat 34 can be configured to communicate directly with the BAC 16 and/or the music service provider for selecting/changing a type of music; as can be appreciated further licensing or subscription requirements may have to be satisfied in this instance.

Additionally, the smart thermostat 34 can be configured to communicate with other smart devices. For example, the GUI 46 can allow a user to synchronize (or register) the smart thermostat 34 with a smart watch (or other smart device) of an occupant, thereby allowing a user the ability to communicate with the smart thermostat 34, the control unit 30, and/or the BAC 16; the smart thermostat 34 can act as a gateway device to the control unit 30 and/or the BAC 16.

Once synchronized or registered to the smart thermostat 34, the smart thermostat 34 can be configured to detect when a smart device of an occupant is located within a proximity thereof. When the smart thermostat 34 detects the smart watch of an occupant, the smart thermostat 34 can be configured to automatically play music of the last channel that was selected by the occupant. Likewise, when the smart thermostat 34 detects that the smart watch of an occupant is no longer in a proximity thereof, the smart thermostat 34 can be configured to automatically stop playing music.

In addition to playing music, the audio capabilities of the HVAC system 12 can be used as an intercom system for the building or in conjunction with an existing intercom system of the building. Intercom systems are known in the art, and, as such, a detailed description of the components of the intercom system is omitted. As can be appreciated, when information needs to be conveyed/broadcast to the occupants of the building (either throughout the building or to a particular space of the building), music that is currently being played can be paused so that the information can be provided to the occupants. For example, information relating to an emergency (e.g., a tornado warning, a fire, active shooter situation, etc.) can be broadcast to the occupants of the building.

As noted above, the one or more sensors 32 can be operably coupled to the VAV boxes 14. In an embodiment, the sensors 32 can be audio or noise sensors that are configured to detect when an audio input received by the microphone 44 is below a predetermined threshold. For example, if a noise caused by conditioned air being provided to a space is detected by the microphone 44 and is determined to fall below a predetermined threshold by the sensor 32, the sensor 32 can transmit a command/request signal to have a sound masking track (white, pink, or other psychoacoustic masking signal) streamed to VAV box 14, which, in turn, is output through speaker 42 to mask (e.g., acoustic masking) or eliminate (e.g., acoustic balancing) the detected noise. Properties of the sound masking track, such as frequency spectrum and/or rhythmic patterns, may selected based in part upon the current operating point of the terminal device, e.g., VAV box 14. In some embodiments, the sound masking track is automatically streamed to VAV box 14 (e.g., without the need for sensor 32 to issue a command/request signal) when VAV 14 is in use. This would provide for near-constant masking sound based on control information without requiring space sensing of sound level. In embodiments, the sound masking track may be mixed with a music track or other streamed program.

Furthermore, in instances where existing BAS systems exist, the present disclosure provides an upgrade kit for the BAS. The upgrade kit includes a non-transitory computer readable storage medium having stored thereon executable instructions that when executed by a controller of the BAS allow the BAS to control one or more VAV boxes 14 to provide audio to one or more spaces of a building. In this instance, the executable instructions when downloaded to a computing architecture of the BAS, allow the BAS to download, via a controller of the BAS, audio from one or more of the above described music servers, to control at least two VAV boxes for regulating a flow of air in a space where each of the at least two VAV boxes is located and to control at least two speakers for outputting the downloaded audio into the space where each of the at least two VAV boxes is located. In embodiments, the upgrade kit includes a loudspeaker and interface/amplifier circuitry configured to receive the provided audio program and drive the loudspeaker.

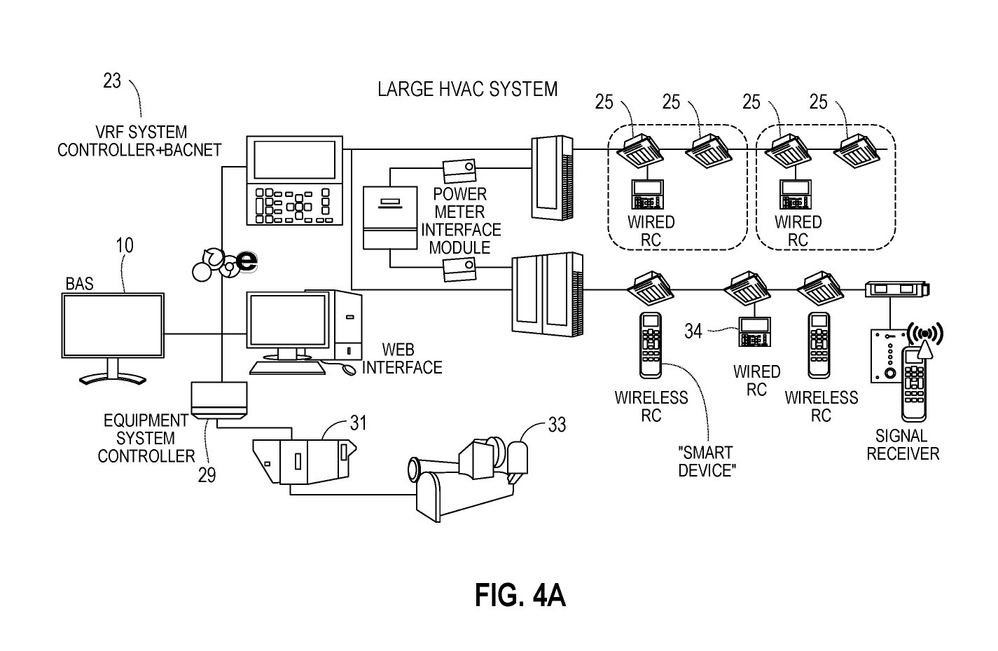

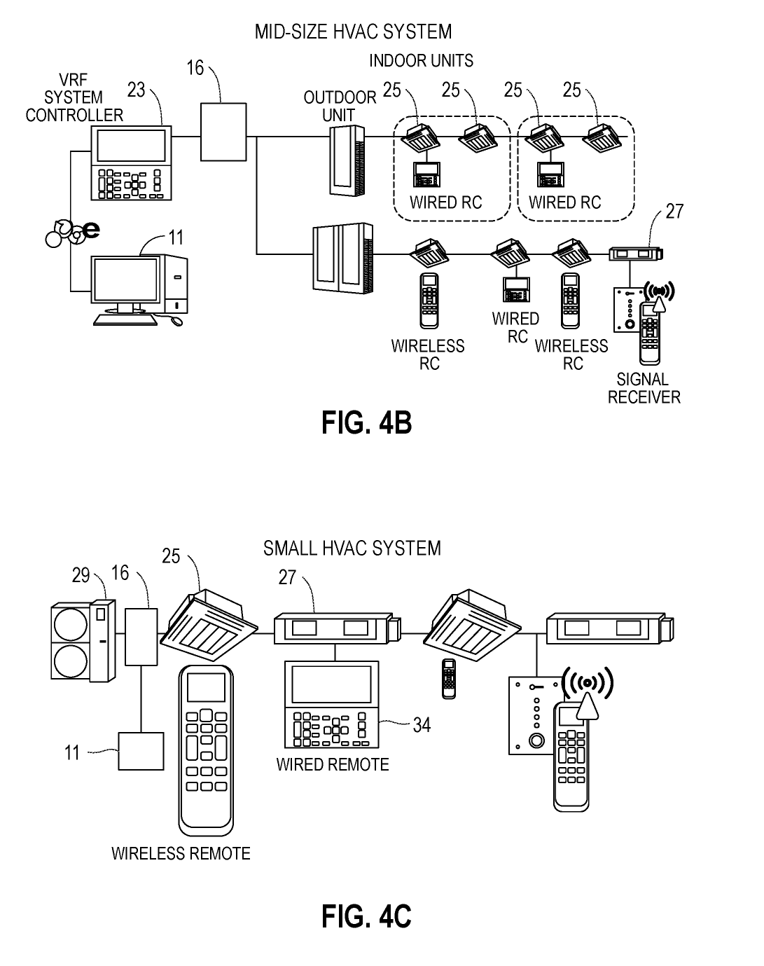

From the foregoing and with reference to the various figure drawings, those skilled in the art will appreciate that certain modifications can also be made to the present disclosure without departing from the scope of the same. For example, as noted above, depending on the specific HVAC system configuration (e.g., large building, small building, etc.), various types of control systems may be used for controlling a particular HVAC system. FIGS. 4A-4C are diagrams of control systems configured for use with the HVAC system 12.

FIG. 4A illustrates a large VRF HVAC system 12 including the BAS 10, a VRF system controller 23, which can be used to control one or more VRF components (e.g., VRF cassette 25, VRF duct 27, high wall unit, etc.), and/or an equipment system controller 29, which can be used to control an outside air unit 31 and other outside equipment of the HVAC system 12. The VRF HVAC system 12 of FIGS. 4B and 4C function similarly to the VRF HVAC system 12 of FIG. 4A, but are used in mid-size and small size HVAC applications.

Unlike the HVAC system 12 described with respect to FIGS. 2A and 2B, the VRF HVAC system 12 of FIGS. 4A-4C includes the speakers 42 and/or the microphones 44 that can be coupled to the VRF cassette 25 or the VRF duct 27, and can be in the operative communication with the BAC 16 and/or the control unit 30 (which can be controlled by the VRF system controller 23 and/or the equipment system controller 29) via one of the aforementioned wired or wireless communication methods.

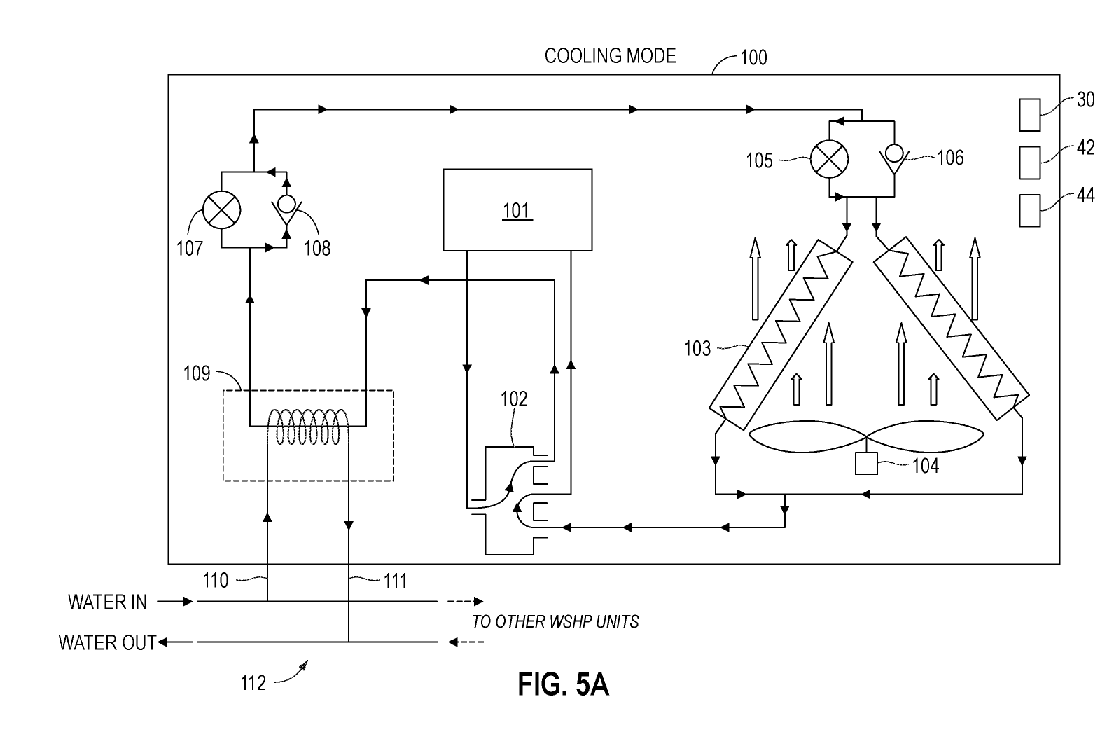

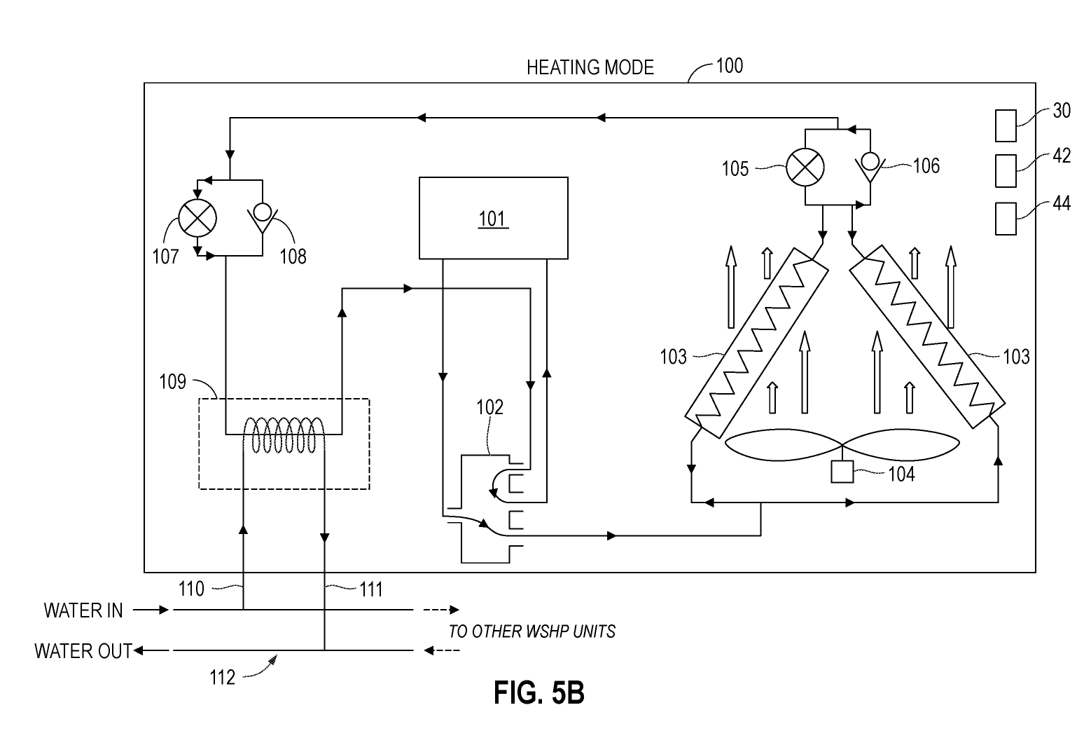

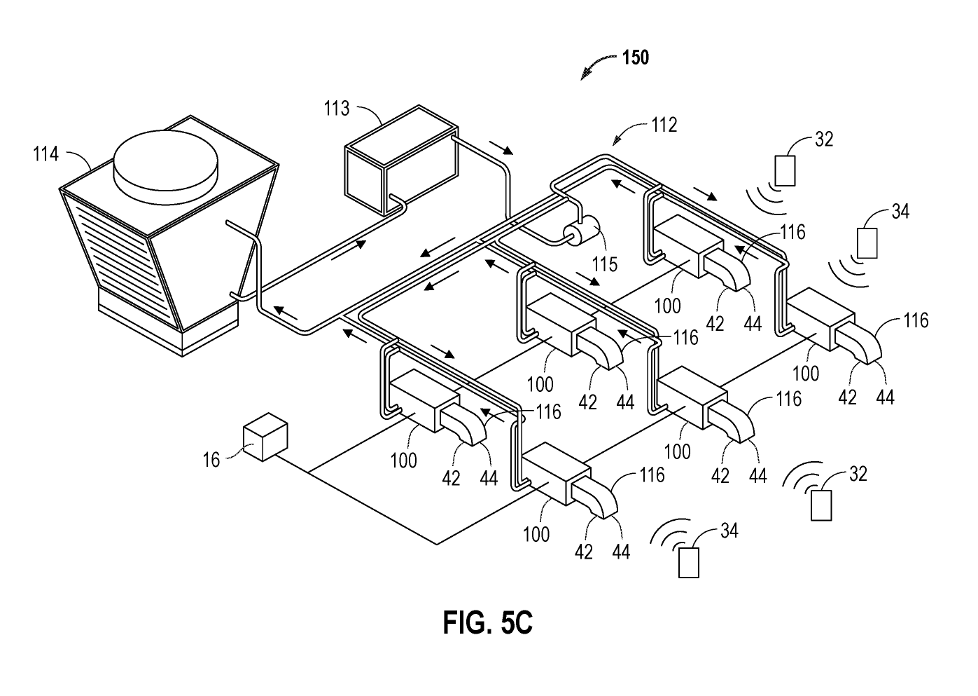

FIG. 5A illustrates a water source heat pump (WSHP) 100 in accordance with another aspect of the present disclosure. WSHP includes compressor 101, reversing valve 102, cooling/heating coil 103, fan 04, refrigerant-to-water heat exchanger 109, thermal expansion valves (TXV) 105, 107, TXV bypass valves 106, 108, control unit 30, speaker 42 and, optionally, microphone 44. A water loop 112 supplies water to water inlet 110 of heat exchanger 109 and receives water from outlet 111 of heat exchanger 109. During cooling mode, reversing valve 102 is set to allow refrigerant to flow from the outlet of compressor 101 through heat exchanger 109, which in cooling mode functions as a condenser to transfer heat from the refrigerant into water supplied by water loop 112. From heat exchanger 109, refrigerant flows through TXV bypass 108 and through TXV 105 and enters coil 103, which, in cooling mode, functions as an evaporator to cool the air of the conditioned space served by WSHP 100. Fan 104 moves air from the conditioned space, through coil 103 where it is cooled and/or dehumidified, and back into the conditioned space. During heating mode, the cycle is reversed. Reversing valve 102 is set to allow refrigerant to flow from the outlet of compressor 101 through coil 103, which in heating mode functions as a condenser to transfer heat from the refrigerant into air of the conditioned space. From coil 103, refrigerant flows through TXV bypass 106 and through TXV 107 and enters heat exchanger 109, which, in cooling mode, functions as an evaporator to transfer heat into the refrigerant from water supplied by water loop 112. As seen in the example embodiment of FIG. 5C, the speaker 42 and/or microphone 44 can be operatively coupled to an outlet duct 116 of WSHP 100.

With continued reference to FIG. 5C, a WSHP system 150 includes one or more WHSP 100 units, a heater 113, a cooling tower 114, and a pump 115 that circulates water from heater 113 through water loop 112 to the WHSP units 100. In cooling mode, heater 113 may deactivated or bypassed to provide chilled water from cooling tower 114 to flow to WHSP units 100. In heating, mode cooling tower 114 may be deactivated or bypassed to conserve heat in the water and therefore provide a higher inlet temperature to heater 113, which promotes greater system efficiency. In some embodiments, a geothermal ground loop is provided in addition to or alternatively to heater 113 and/or cooling tower 114. Sensors 32, thermostat 34, and/or control unit 30, can be connected to BAC 16 in a variety of ways as described above.

A detailed description of the operation of the VRF HVAC system 12 of FIGS. 4A-4C and the WSHP 100 of FIGS. 5A-5C, with respect to the audio output functionality, is omitted, as it is identical (or substantially similar) to the operation of the previously described HVAC system 12.

### ASPECTS

It is noted that any of aspects 1-20 may be combined with each other in any suitable combination.

Aspect 1. A control system configured for use with a heating, ventilation and air condition system (HVAC). The system comprising a terminal device disposed proximate to a space in which the system is configured to regulate a flow of air; an audio output device operatively coupled to the terminal device and configured to output audio into the space; and a controller that is communicatively coupled to each of the terminal device and the audio output device for control thereof.

Aspect 2. The control system in accordance with aspect 1, wherein the terminal device is one of a variable air-volume (VAV) box, a fan coil, a blower coil, a ventilator, a variable refrigerant flow (VRF) cassette, a personal terminal air conditioner (PTAC), a water source heat pump (WSHP), a cooling coil, and a chilled beam cassette.

Aspect 3. The control system in accordance with any of aspects 1-2, wherein the audio output device is incorporated into a register that is operatively coupled to the VAV box.

Aspect 4. The control system in accordance with any of aspects 1-3, wherein the audio output device is a speaker.

Aspect 5. The control system in accordance with any of aspects 1-4, wherein the controller communicates with the terminal device and the audio output device via a wired interface and/or wireless interface.

Aspect 6. The control system in accordance with any of aspects 1-5, wherein the wireless interface is one of AirFi and wireless-fidelity (WiFi).

Aspect 7. The control system in accordance with any of aspects 1-6, further comprising a microphone that is operatively coupled to the terminal device and configured to detect an audio input.

Aspect 8. The control system in accordance with any of aspects 1-7, wherein when an audio input detected by the microphone is less than or equal to a predetermined value, the controller controls a white noise generator to output white noise through the audio output device.

Aspect 9. The control system in accordance with any of aspects 1-8, wherein the audio output by the audio output device is provided by one of a music service provider and music that is stored on one of a local network server, a cloud based server, a connected smart device and an intercom based single input.

Aspect 10. The BAS in accordance with any of aspects 1-9, wherein the controller is communicatively couplable to a smart device including one of a smart watch, a smart phone, a smart tablet, smart remote, and a smart thermostat for allowing a user of one of the smart devices to control a type of audio output by the audio output device.

Aspect 11. A building automation system (BAS), the BAS comprising a plurality of terminal devices, each capable of regulating a flow of air into an adjacent space; a plurality of speakers, each operatively coupled to a corresponding one of the plurality of terminal devices and configured to output audio; and a controller that is communicatively coupled to the plurality of terminal devices and the plurality of speakers for control thereof.

Aspect 12. The BAS in accordance with aspect 11, wherein each of the plurality of speakers is incorporated into a register of a corresponding one of the plurality of terminal devices.

Aspect 13. The BAS in accordance with any of aspects 11-12, wherein the controller communicates with the plurality of terminal devices and the plurality of speakers via a wired interface and/or wireless interface.

Aspect 14. The BAS in accordance with any of aspects 11-13, wherein the wireless interface is one of AirFi and wireless-fidelity (WiFi).

Aspect 15. The BAS in accordance with any of aspects 11-14, further comprising a plurality of microphones, each microphone operatively coupled to a corresponding one of the plurality of terminal devices and configured to detect an audio input.

Aspect 16. The BAS in accordance with any of aspects 11-15, wherein when an audio input detected by the microphones is less than or equal to a predetermined value, the controller controls a white noise generator to output white noise through a corresponding one of the plurality of speakers.

Aspect 17. The BAS in accordance with any of aspects 11-16, wherein the audio output by the plurality of speakers is provided by one of a music service provider and music that is stored on one of a local network server, a cloud based server, a connected smart device and an intercom based single input.

Aspect 18. The BAS in accordance with any of aspects 11-17, wherein the controller is communicatively couplable to a smart device including one of a smart watch, a smart phone, a smart tablet, smart remote, and a smart thermostat for allowing a user of one of the smart devices to control a type of audio output by the plurality of speakers.

Aspect 19. An upgrade kit for a control system) including at least one terminal device and at least one speaker operatively coupled to the at least one terminal device, the upgrade kit including a non-transitory computer readable storage medium having stored thereon executable instructions that when executed by a controller of the control system perform a method comprising downloading, via the controller, audio from a music server; controlling the at least one terminal device for regulating a flow of air in a space where the at least one terminal device is located; and controlling the at least one speaker for outputting the downloaded audio into the space where the at least one terminal device is located.

Aspect 20. The upgrade kit in accordance with aspect 19, further comprising at least two terminal devices and at least two speakers operatively coupled to a corresponding one of the at least two terminal device, wherein the at least two speakers output different audio.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in any appropriately detailed structure.

1. A control system configured for use with a heating, ventilation and air condition system (HVAC) in a building having common areas and individual areas, the system comprising:
a terminal device disposed proximate to a space in which the control system is configured to regulate a flow of air;
an audio output device operatively coupled to the terminal device and configured to output audio into the space;
a controller that is communicatively coupled to each of the terminal device and the audio output device for control thereof, wherein the controller causes a default common audio channel to the played through the audio output device; and
a thermostat positioned within an individual area and operatively coupled to the controller and configured to detect a smart device of an occupant,
wherein when the thermostat detects that a smart device of an occupant is located within a proximity of the thermostat, the last channel that was selected by the occupant is played, without requiring a user input, through the audio output device.

2. The control system of claim 1, wherein the terminal device is one of a variable air-volume (VAV) box, a fan coil, a blower coil, a ventilator, a variable refrigerant flow (VRF) cassette, a personal terminal air conditioner (PTAC), water source heat pump (WSHP), cooling coil, and a chilled beam cassette.

3. The control system of claim 2, wherein the audio output device is incorporated into a register that is operatively coupled to the VAV box.

4. The control system of claim 1, wherein the audio output device is a speaker.

5. The control system of claim 1, wherein the controller communicates with the terminal device and the audio output device via a wired interface and/or wireless interface.

6. The control system of claim 4, wherein the wireless interface is one of AirFi and wireless-fidelity (WiFi).

7. The control system of claim 1, further comprising a microphone that is operatively coupled to the terminal device and configured to detect an audio input.

8. The control system of claim 7, wherein when an audio input detected by the microphone is less than or equal to a predetermined value, the controller controls a white noise generator to output white noise through the audio output device.

9. The control system of claim 1, wherein the audio output by the audio output device is provided by one of a music service provider and music that is stored on one of a local network server, a cloud based server, a connected smart device and an intercom based single input.

10. The control system of claim 1, wherein the smart device is selected from the group consisting of a smart watch, a smart phone, a smart tablet, and a smart remote.

11. A building automation system (BAS), the BAS comprising:
a plurality of terminal devices, each associated with an adjacent space selected from the group consisting of a common space and an individual space;
a plurality of speakers, each operatively coupled to a corresponding one of the plurality of terminal devices and configured to output audio;
a plurality of thermostats, each associated with a corresponding one of the individual spaces and configured to detect the presence of a smart device of an occupant within the corresponding one of the individual spaces;
a controller that is communicatively coupled to the plurality of terminal devices, the plurality of speakers, and the plurality of thermostats,
wherein the controller causes a default common audio channel to the played through the plurality of speakers;
wherein when any one of the plurality of thermostats detects the presence of a smart device within the individual space of said thermostat the last channel that was selected by the smart device is played, without requiring a user input, through the speaker of the terminal device of the individual space.

12. The BAS of claim 11, wherein each of the plurality of speakers is incorporated into a register of a corresponding one of the plurality of terminal devices.

13. The BAS of claim 11, wherein the controller communicates with the plurality of terminal devices and the plurality of speakers via a wired interface and/or wireless interface.

14. The BAS of claim 13, wherein the wireless interface is one of AirFi and wireless-fidelity (WiFi).

15. The BAS of claim 11, further comprising a plurality of microphones, each microphone operatively coupled to a corresponding one of the plurality of terminal devices and configured to detect an audio input.

16. The BAS of claim 15, wherein when an audio input detected by the microphones is less than or equal to a predetermined value, the controller controls a white noise generator to output white noise through a corresponding one of the plurality of speakers.

17. The BAS of claim 11, wherein the audio output by the plurality of speakers is provided by one of a music service provider and music that is stored on one of a local network server, a cloud based server, a connected smart device and an intercom based single input.

18. The BAS of claim 11, wherein the smart device is selected from the group consisting of a smart watch, a smart phone, a smart tablet, and a smart remote.

19. An upgrade kit for a control system configured for use with a heating, ventilation and air condition system (HVAC) including, a speaker operatively coupled to a terminal device in a common area, a speaker operatively coupled to a terminal device in a private area, and a thermostat operatively coupled to each terminal device, the upgrade kit including a non-transitory computer readable storage medium having stored thereon executable instructions that when executed by a controller of the control system perform a method comprising:
streaming, via the controller, a default common area audio channel from a music server;
controlling the terminal device for regulating a flow of air in a space where the terminal device is located; and
controlling the speaker for outputting the streamed audio into the space where the terminal box is located, wherein controlling the speaker comprises:
playing the common area audio channel through the speaker;
detecting, by the thermostat, whether a smart device of an occupant is located within a proximity of the thermostat;
beginning playback, without requiring a user input, of the last channel that was selected by the occupant through the speaker when the smart device of an occupant is detected within a proximity of the thermostat.

20. (canceled)
